(19) United States
(12) Patent Application Publication
(10) Pub. No.: US 2024/0361075 A1
(43) Pub. Date: Oct. 31, 2024

(54) HEAT TREATMENT FURNACE

(71) Applicants: NGK INSULATORS, LTD., Nagoya-Shi (JP); NGK KILNTECH, CORPORATION, Nagoya-Shi (JP)

(72) Inventors: Terukazu IWATA, Nagoya-Shi (JP); Takeshi KOMAKI, Nagoya-Shi (JP); Minoru YAMAGUCHI, Nagoya-Shi (JP); Kazuya NARUMIYA, Nagoya-Shi (JP)

(73) Assignees: NGK INSULATORS, LTD., Nagoya-Shi (JP); NGK KILNTECH, CORPORATION, Nagoya-Shi (JP)

(21) Appl. No.: 18/632,445

(22) Filed: Apr. 11, 2024

(30) Foreign Application Priority Data
Apr. 25, 2023 (JP) 2023-071607

(51) Int. Cl. F27B 9/36; F27D 1/00; F27D 3/00; F27D 5/00; H05B 3/06

(52) U.S. Cl. CPC F27B 9/36; F27D 1/0036; F27D 5/0012; H05B 3/06; F27B 2009/3638; F27D 2003/0042; H05B 2203/037

(57) ABSTRACT

A heat treatment furnace may include: a furnace body comprising an entrance, an exit, and a heat treatment space having a temperature-rising space and a temperature-maintained space that are configured to thermally treat a plurality of objects; conveying plates on which the plurality of objects is to be placed; a pusher configured to push the conveying plates in a front direction from the entrance to the exit of the furnace body; and a plurality of heaters extending in an up-down direction and aligned in the front direction in the heat treatment space. Each of the plurality of heaters may include a heating part configured to generate heat. Positions of the heating parts of the plurality of heaters in the up-down direction may vary from the heater closest to the entrance toward the heater closest to the exit.

### REFERENCE TO RELATED APPLICATIONS

This application claims priority to Japanese Patent Application No. 2023-071607, filed on Apr. 25, 2023, the entire contents of which are hereby incorporated by reference into the present application.

### TECHNICAL FIELD

The disclosure herewith relates to a heat treatment furnace.

### BACKGROUND ART

Japanese Patent Application Publication No. 2021-162245 describes a heat treatment furnace configured to thermally treat objects. The heat treatment furnace includes a furnace body including an entrance and an exit, and a plurality of heaters aligned in a front direction from the entrance toward the exit in the furnace body. Each of the plurality of heaters extends in an up-down direction.

### SUMMARY

In a heat treatment furnace like the one in Japanese Patent Application Publication No. 2021-162245, the objects are thermally treated by the plurality of heaters in a state of being stacked on top of each other in the up-down direction. Due to this, the objects stacked in the up-down direction may be heated unevenly with respect to the up-down direction.

The present teachings provide an art configured to suppress uneven heating in an up-down direction from occurring among a plurality of objects stacked in the up-down direction.

In a first aspect of the art disclosed herein, a heat treatment furnace may comprise: a furnace body comprising an entrance, an exit, and a heat treatment space having a temperature-rising space and a temperature-maintained space that are configured to thermally treat a plurality of objects; conveying plates on which the plurality of objects is to be placed in a state of being stacked on one another in an up-down direction; a pusher configured to push the conveying plates in a front direction from the entrance to the exit of the furnace body; and a plurality of heaters extending in the up-down direction and aligned in the front direction in the heat treatment space. Each of the plurality of heaters may comprise a heating part configured to generate heat, and positions of the heating parts of the plurality of heaters in the up-down direction may vary from the heater closest to the entrance toward the heater closest to the exit.

According to the above configuration, the positions of the heating parts of the plurality of heaters in the up-down direction vary within the furnace body. Due to this, an occurrence of a situation where a certain object among the plurality of objects stacked on top of each other in the up-down direction is heated excessively compared to other objects can be suppressed. For this reason, uneven heating in the up-down direction can be suppressed from occurring among the plurality of objects stacked in the up-down direction.

### BRIEF DESCRIPTION OF DRAWINGS

FIG. 1 illustrates a schematic cross-sectional view of a heat treatment furnace according to a first embodiment.

FIG. 2 illustrates a schematic cross-sectional view of the heat treatment furnace taken along a II-II line in FIG. 1.

FIG. 3 illustrates a side view of a plurality of objects placed on conveying plates according to the first embodiment.

FIG. 4 illustrates a cross-sectional view of a vertical heater and a guide rail part according to the first embodiment.

FIG. 5 illustrates a schematic cross-sectional view of the heat treatment furnace near a heat-treatment space in the first embodiment.

FIG. 6 illustrates a top view of a plurality of lower heaters according to the first embodiment.

FIG. 7 illustrates a schematic cross-sectional view of the heat treatment furnace near one of the lower heaters in the first embodiment.

FIG. 8 illustrates a schematic cross-sectional view of a heat treatment furnace near a heat treatment space in a second embodiment.

FIG. 9 illustrates a schematic cross-sectional view of a heat treatment furnace near a heat treatment space in a third embodiment.

FIG. 10 illustrates a schematic cross-sectional view of a heat treatment furnace near a heat treatment space in a fourth embodiment.

FIG. 11 illustrates a top view of a plurality of lower heaters according to a fifth embodiment.

FIG. 12 illustrates a schematic view of a lower heater according to a sixth embodiment.

### DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved heat treatment furnaces, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Some of the features characteristic to below-described embodiments will herein be listed. It should be noted that the respective technical elements are independent of one another, and are useful solely or in combinations. The combinations thereof are not limited to those described in the claims as originally filed.

In a second aspect of the art disclosed herein, in the above-mentioned first aspect, the front direction is perpendicular to the up-down direction. The conveying plates are conveyed from the entrance to the exit by being pushed by the pusher with the conveying plates aligned in a left-right direction perpendicular to the up-down direction and the front direction. the plurality of the heaters comprises: a plurality of first heaters disposed between adjacent ones of the conveying plates in the left-right direction; a plurality of second heaters aligned in the front direction and disposed between a right end of the conveying plates aligned in the left-right direction and the furnace body; and a plurality of third heaters aligned in the front direction and disposed between a left end of the conveying plates aligned in the left-right direction and the furnace body. Within the temperature-rising space, an amount of heat generation of each of the first heaters is greater than any of an amount of heat generation of each of the second heaters and an amount of heat generation of each of the third heaters. According to the above configuration, the first heaters are arranged between the objects that are adjacent in the left-right direction. Due to this, each of the first heaters heats both the object on a right side of the first heater and the object on a left side of the first heater. Also, the second heaters are adjacent to the objects that are positioned rightmost. Due to this, the second heaters heat only the rightmost objects. Further, the third heaters are adjacent to the objects positioned leftmost. Due to this, the third heaters heat only the leftmost objects. For example, when the heat generation amount of each first heater is smaller than any of the heat generation amount of each second heater and the heat generation amount of each third heater, the objects on the right and left sides of each first heater are heated less than the leftmost objects and the rightmost objects. Thus, uneven heating with respect to the left-right direction occurs among the plurality of objects aligned in the left-right direction. According to the above configuration, since the heat generation amount of each first heater is greater than any of the heat generation amount of each second heater and the heat generation amount of each third heater, uneven heating with respect to the left-right direction among the plurality of objects aligned in the left-right direction can be suppressed from occurring.

In a third aspect of the art disclosed herein, in the above-mentioned second aspect, the amount of heat generation of each of the first heaters is equal to or more than 1.3 times and equal to or less than 2.7 times the amount of heat generation of each of the second heaters. The amount of heat generation of each of the second heaters is substantially equal to the amount of heat generation of each of the third heaters. According to the above configuration, uneven heating with respect to the left-right direction among the plurality of objects aligned in the left-right direction can be further suppressed from occurring.

In a fourth aspect of the art disclosed herein, in one of the above-mentioned first to third aspects, the front direction is perpendicular to the up-down direction. The furnace body comprises: a ceiling wall into which the plurality of heaters is inserted; and a receiver configured to receive lower ends of the plurality of heaters. According to the above configuration, because the lower ends of the heaters are received by the receiver, the heaters can be suppressed from being deformed by warping in the left-right direction due to a long-time use. Due to this, the heaters can be suppressed from contacting the objects.

In a fifth aspect of the art disclosed herein, in the above-mentioned fourth aspect, the heat treatment furnace further comprises a guide rail part configured to guide the conveying plates in the front direction. The receiver is arranged on an upper surface of the guide rail part. According to the above configuration, the heaters and the conveying plates can be surely separated from each other, and also a number of components can be suppressed from increasing.

In a sixth aspect of the art disclosed herein, in the above-mentioned fourth or fifth aspect, an inner width of the receiver is equal to or more than 1.1 times and equal to or less than 2.0 times a width of each of the plurality of heaters in a left-right direction perpendicular to the up-down direction and the front direction. If the inner width of the receiver is less than 1.1 times the width of each heater, when the heaters thermally expand, they may be pressed against the receiver and thereby be broken. If the inner width of the receiver is more than twice the width of each heater, when the heaters deform by warping in the left-right direction, the lower ends of that heaters may slip out of the receiver. According to the above configuration, each of the heaters can be suppressed from being broken upon thermal expansion, and also the lower end of each heater can be suppressed from slipping out of the receiver when each heater deforms by warping in the left-right direction.

In a seventh aspect of the art disclosed herein, in one of the above-mentioned first to sixth aspects, the heat treatment furnace further comprises a protecting member configured to cover the plurality of heaters. According to the above configuration, substance(s) generated due to the heat treatment of the objects can be suppressed from contacting the heaters. Due to this, life of the heaters can be lengthened.

In an eighth aspect of the art disclosed herein, in one of the above-mentioned first to seventh aspects, the heat treatment furnace comprises a spacer disposed between the conveying plates and the objects. If the objects are placed directly on the conveying plates, lower surfaces of the objects which are in contact with the conveying plates may not be heated efficiently. According to the above configuration, the lower surfaces of the objects on the conveying plates can be heated.

In a ninth aspect of the art disclosed herein, in one of the above-mentioned first to eighth aspects, the front direction is perpendicular to the up-down direction. The furnace body comprises a left sidewall and a right sidewall facing each other in a left-right direction perpendicular to the up-down direction and the front direction. The heat treatment furnace comprises: a plurality of fourth heaters disposed below the conveying plates, aligned in the front direction, and penetrating the right sidewall to extend from the right sidewall toward the left sidewall in the furnace body, and a plurality of fifth heaters disposed below the conveying plates, aligned in the front direction, and penetrating the left sidewall to extend from the left sidewall toward the right sidewall in the furnace body. An end of each of the plurality of fourth heaters and an end of corresponding one of the plurality of fifth heaters are separated and face each other in the left-right direction. A facing region is defined between the end of each of the plurality of fourth heaters and the end of the corresponding one of the plurality of fifth heaters in the left-right direction. Positions in the left-right direction of the facing regions vary between the facing region positioned closest to the entrance and the facing region closest to the exit. If the positions of the facing regions in the left-right direction are constant between the facing region positioned closest to the entrance and the facing region positioned closest to the exit, the positions of spaces directly above the facing regions in the left-right direction are always constant. Due to this, uneven heating of the objects is likely to occur. According to the above configuration, the positions of the spaces directly above the facing regions vary between the facing region closest to the entrance and the facing region closest to the exit. Due to this, uneven heating of the objects can be suppressed from occurring.

In a tenth aspect of the art disclosed herein, in the above-mentioned ninth aspect, each of the plurality of fourth heaters comprises a heating part and a non-heating part extending in the left-right direction. Each of the plurality of fifth heaters comprises a heating part and a non-heating part extending in the left-right direction. Positions of the non-heating parts of adjacent ones of the plurality of fourth heaters in the front direction differ from each other in the left-right direction. Positions of the non-heating parts of adjacent ones of the plurality of fifth heaters in the front direction differ from each other in the left-right direction. In one of the plurality of fourth heaters and one of the plurality of fifth heaters that are adjacent in the front direction, the non-heating part of the fourth heater faces the heating part of another fourth heater or faces the heating part of the adjacent fifth heater in the front direction, and the non-heating part of the fifth heater faces the heating part of the adjacent fourth heater or faces the heating part of another fifth heater in the front direction. According to the above configuration, uneven heating with respect to the left-right direction of the plurality of objects aligned in the left-right direction can be suppressed from occurring.

In an eleventh aspect of the art disclosed herein, in the above-mentioned ninth or tenth aspect, the front direction is perpendicular to the up-down direction. The heat treatment furnace further comprises a plurality of guide rail parts, each of the plurality of guide rail parts being disposed between the conveying plates aligned in the left-right direction and configured to guide the conveying plates in the front direction. Each of the plurality of guide rail parts extends in the front direction. The plurality of guide rail parts is disposed above the plurality of fourth heaters and the plurality of fifth heaters and separated from each other in the left-right direction. Each of the facing regions is disposed at a position where the facing region overlaps one of the plurality of guide rail parts in the up-down direction. According to the above configuration, the guide rail part is positioned immediately above each facing region (region defined between the ends of each pair of the fourth heater and the fifth heater) and no objects are arranged immediately above each facing region. Due to this, uneven heating of the objects can be suppressed from occurring.

In a twelfth aspect of the art disclosed herein, in the above-mentioned eleventh aspect, positions in the left-right direction of two of the facing regions adjacent in the front direction differ from each other. According to the above configuration, uneven heating of the objects can be suppressed from occurring.

In a thirteenth aspect of the art disclosed herein, in one of the above-mentioned ninth to twelfth aspects, the heat treatment furnace further comprises a support configured to support the ends of the plurality of fourth heaters and the ends of the plurality of fifth heaters. According to the above configuration, deformation of the fourth and fifth heaters in a manner that positions of the ends of the fourth heaters and the ends of the fifth heaters lower down can be suppressed.

### FIRST EMBODIMENT

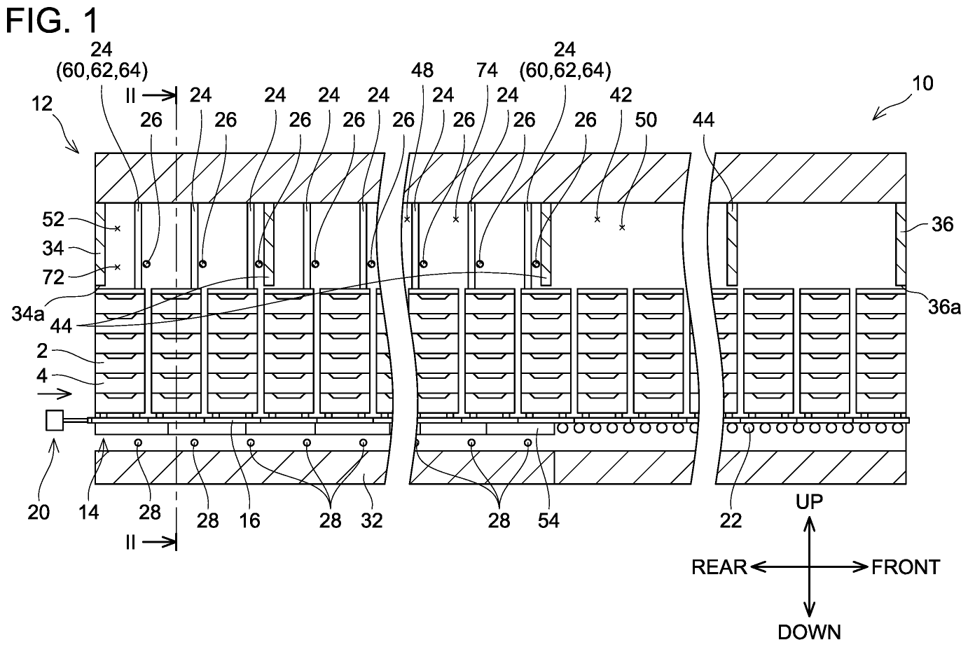

A heat treatment furnace 10 according to a first embodiment shown in FIG. 1 is configured to thermally treat objects 2. The objects 2 include saggars 4 and articles to be subjected to heat treatment (not shown). Each of the saggars 4 has a box shape of substantially cuboid. The articles are housed in the respective saggars 4. The articles are raw materials of a ceramic capacitor, and a positive electrode material and a negative electrode material of a lithium-ion battery. Hereafter, a longitudinal direction the heat treatment furnace 10 will be referred to as a front-rear direction, a direction perpendicular to the front-rear direction will be referred to as a left-right direction, and a direction perpendicular to the front rear direction and the left-right direction will be referred to as an up-down direction.

The heat treatment furnace 10 comprises a furnace body 12, a furnace floor part 14, conveying plates 16, a plurality of spacers 18, a pusher 20, conveying rollers 22, a plurality of vertical heaters 24, a plurality of upper heaters 26, and a plurality of lower heaters 28.

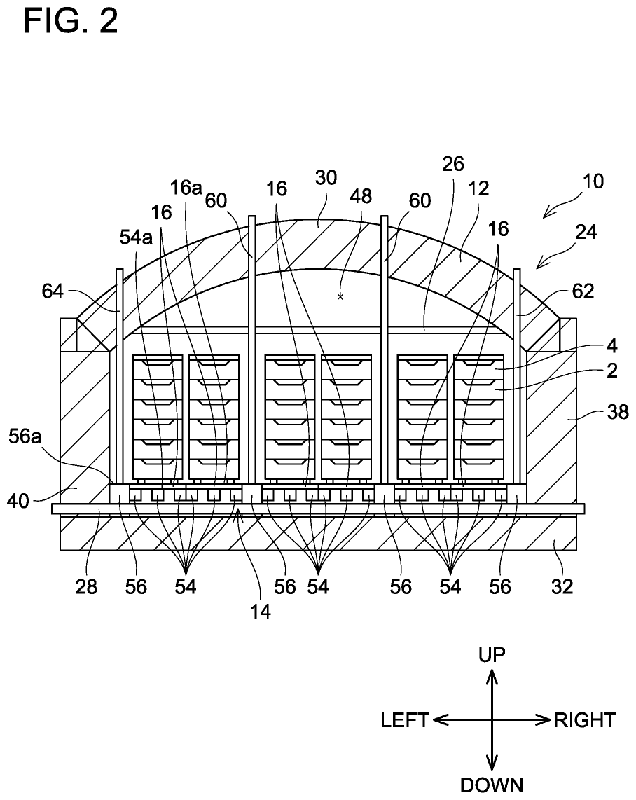

The furnace body 12 is a heat insulation structure of a substantially cuboid shape extending in the front-rear direction. The furnace body 12 comprises a ceiling wall 30, a bottom wall 32, a furnace entrance wall 34, a furnace exit wall 36, a right sidewall 38, and a left sidewall 40. The ceiling wall 30, the bottom wall 32, the furnace entrance wall 34, the furnace exit wall 36, the right sidewall 38, and the left sidewall 40 define an internal space 42 of the furnace body 12. The ceiling wall 30 and the bottom wall 32 extend in the front-rear direction. The ceiling wall 30 is disposed above the bottom wall 32. The furnace entrance wall 34 is connected with a rear end of the ceiling wall 30 and a rear end of the bottom wall 32. The furnace entrance wall 34 has an entrance 34a penetrating the furnace entrance wall 34 in the front-rear direction. The internal space 42 is in communication with outside the furnace body 12 through the entrance 34a. The furnace exit wall 36 is connected with a front end of the ceiling wall 30 and a front end of the bottom wall 32. The furnace exit wall 36 has an exit 36a penetrating the furnace exit wall 36 in the front-rear direction. The internal space 42 is in communication with outside the furnace body 12 through the exit 36a. The exit 36a is opposed to the entrance 34a in the front-rear direction. As shown in FIG. 2, the right sidewall 38 and the left sidewall 40 are apart from each other in the left-right direction. The right sidewall 38 is opposed to the left sidewall 40 in the left-right direction. The right sidewall 38 and the left sidewall 40 are connected to the ceiling wall 30, the bottom wall 32, the furnace entrance wall 34 (see FIG. 1), and the furnace exit wall 36 (see FIG. 1).

As shown in FIG. 1, the furnace body 12 further comprises a plurality of partitioning walls 44. The plurality of partitioning walls 44 is aligned in the front-rear direction. The plurality of partitioning walls 44 extends downward from the ceiling wall 30. The plurality of partitioning walls 44 partitions the internal space 42 into plural spaces.

The internal space 42 comprises a heat treatment space 48 and a cooling space 50. The heat treatment space 48 is defined by the ceiling wall 30, the bottom wall 32, the furnace entrance wall 34, the right sidewall 38 (see FIG. 2), the left sidewall 40 (see FIG. 2), and one of the partitioning walls 44 located at a boundary with the cooling space 50. The heat treatment space 48 is disposed at a rear portion of the furnace body 12. Also, the heat treatment space 48 is divided into a plurality of spaces 52 by the partitioning walls 44. The plurality of vertical heaters 24, the plurality of upper heaters 26, and the plurality of lower heaters 28 are arranged in the heat treatment space 48. When the plurality of vertical heaters 24, the plurality of upper heaters 26, and the plurality of lower heaters 28 generate heat, the heat treatment space 48 is heated. Due to this, the objects 2 within the heat treatment space 48 are heated.

The cooling space 50 is disposed at a front portion of the furnace body 12. The cooling space 50 is defined by the ceiling wall 30, the bottom wall 32, the furnace exit wall 36, the right sidewall 38, the left sidewall 40, and one of the partitioning walls 44 at the boundary with the heat treatment space 48. The cooling space 50 is divided into plural spaces by the partitioning walls 44. Cooling pipes (not shown) are arranged in the cooling space 50. The cooling space 50 is cooled by water or air flowing in the cooling pipes. Due to this, the objects 2 within the cooling space 50 are cooled.

The furnace floor part 14 is arranged in the heat treatment space 48. The furnace floor part 14 is constituted of ceramics. The furnace floor part 14 comprises a plurality of placement parts 54 and a plurality of guide rail parts 56.

Each of the placement parts 54 has a substantially cuboid shape. Each placement part 54 extends in the front-rear direction. As shown in FIG. 2, the plurality of placement parts 54 is aligned in the left-right direction. An upper surface 54a of each placement part 54 is disposed so as to be perpendicular to the up-down direction, that is, to be positioned on a plane parallel to the left-right direction and the front-rear direction. The upper surfaces 54a of the plurality of placement parts 54 are arranged on a same plane.

Each of the guide rail parts 56 has a substantially cuboid shape. Each guide rail part 56 extends in the front-rear direction. The plurality of guide rail parts 56 is apart from one another in the left-right direction. An upper surface 56a of each guide rail part 56 is disposed so as to be perpendicular to the up-down direction, that is, to be positioned on a plane parallel to the left-right direction and the front-rear direction. The upper surfaces 56a of the plurality of guide rail parts 56 are arranged on a same plane. The upper surfaces 56a of the guide rail parts 56 are arranged slightly above the upper surfaces 54a of the placement parts 54. Each of side surfaces of the guide rail parts 56 are disposed so as to be perpendicular to the left-right direction, that is, to be positioned on a plane parallel to the front-rear direction and the up-down direction.

The conveying plates 16 have a flat plate shape. The conveying plates 16 are constituted of ceramics. Each of the conveying plates 16 has an upper surface 16a on which a plurality of the objects 2 can be placed. The plurality of (in the present embodiment, six) objects 2 are stacked in the up-down direction. The plurality of objects 2 is arranged in a plurality of rows in the left-right direction. In a modification, the plurality of objects 2 may be aligned in plural rows in the front-rear direction on the upper surface 16a of one of the conveying plates 16.

The conveying plates 16 are arranged on the upper surfaces 54a of the placement parts 54. The conveying plates 16 are supported by the placement parts 54. A plurality (two in the present embodiment) of the conveying plates 16 is arranged between adjacent ones in the left-right direction of the guide rail parts 56. Also, each of the guide rail parts 56 is disposed between two of the conveying plates 16 arranged side by side in the left-right direction. A total of width of the two conveying plates 16 in the left-right direction is slightly smaller than an interval between the adjacent guide rail parts 56 in the left-right direction. The conveying plates 16 move frontward in the internal space 42 of the furnace body 12 by being pushed by the pusher 20 (see FIG. 1). While the conveying plates 16 are moving in the heat treatment space 48, the objects 2 are thermally treated. Similarly, while the conveying plates 16 are moving in the cooling space 50, the objects 2 are cooled. The conveying plates 16 slide on the upper surfaces 54a of the placement parts 54 while being guided frontward by the guide rail parts 56.

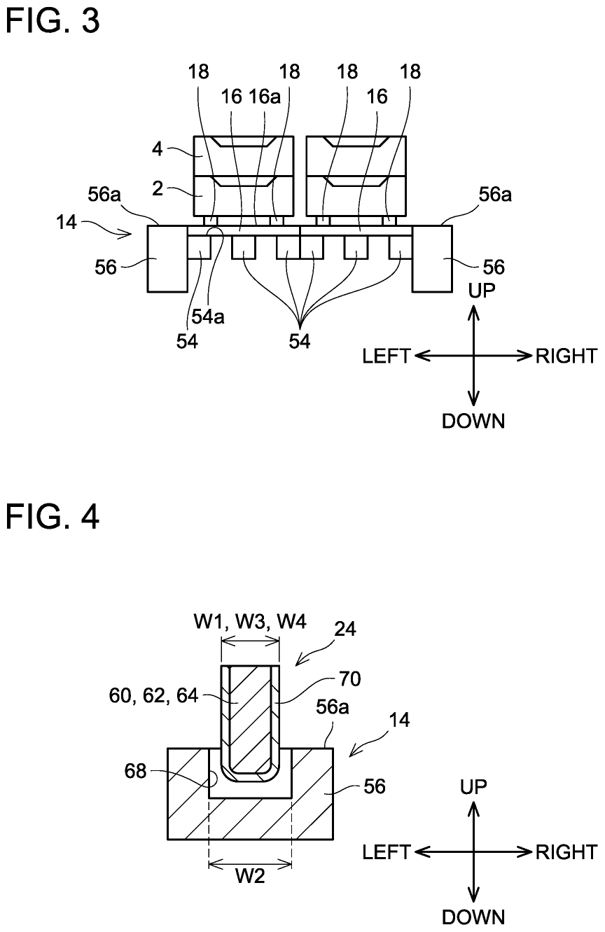

As shown in FIG. 3, each of the spacers 18 has a substantially cuboid shape. A plurality (two in the present embodiment) of the spacers 18 is arranged between a pair of the conveying plate 16 and the object 2 that face each other. The spacers 18 are constituted of ceramics. Each spacer 18 is configured to make a lower surface of the object 2 located lowermost among the six objects 2 stacked in the up-down direction detached from the conveying plates 16. Due to this, the lowermost objects 2 can be suppressed from being late in rising temperature or cooling relative to the other objects 2.

As shown in FIG. 1, the pusher 20 is disposed outside the furnace body 12, near the entrance 34a. The pusher 20 is configured to push the conveying plates 16 frontward. In the present embodiment, the pusher 20 is configured to push the six conveying plates 16 aligned in the left-right direction frontward concurrently. Due to this, the six conveying plates 16 move from the entrance 34a into the internal space 42, and thus the plurality of conveying plates 16 within the internal space 42 is pushed out frontward by such movement of the six conveying plates 16. The pusher 20 repeatedly pushes the conveying plates 16, by which the conveying plates 16 are transferred through the entrance 34a into the internal space 42, the conveying plates 16 pass sequentially through the heat treatment space 48 and the cooling space 50, and then the conveying plates 16 are discharged from the exit 36a outside the furnace body 12. In a modification, a plurality of the pushers 20 may be disposed outside the furnace body 12 in proximity to the entrance 34a. A number of the conveying plates 16 which each of the plural pushers 20 is configured to push may be one or may be plural (e.g., two). Here, a configuration of the pusher(s) 20 is well-known and thus description thereof may be omitted.

The plurality of conveying rollers 22 is arranged in the cooling space 50. The conveying rollers 22 are constituted of a metal or ceramics, for example. The conveying rollers 22 are arranged at intervals in the front-rear direction. Both ends of the conveying rollers 22 are rotatably supported onto the right sidewall 38 and the left sidewall 40. When the conveying plates 16 are pushed frontward by the pusher 20, the plurality of conveying rollers 22 is caused to rotate by friction generated between the conveying plates 16 and the plurality of conveying rollers 22. The conveying plates 16 move frontward on the plurality of conveying rollers 22 in the cooling space 50.

The plurality of vertical heaters 24 is arranged in the heat treatment space 48. As shown in FIGS. 1 and 2, the plurality of vertical heaters 24 comprises a plurality of first vertical heaters 60, a plurality of second vertical heaters 62, and a plurality of third vertical heaters 64.

As shown in FIG. 1, each of the first vertical heaters 60 extends in the up-down direction. The plurality of first vertical heaters 60 is spaced from each other in the front-rear direction. As shown in FIG. 2, the plurality of first vertical heaters 60 is spaced from each other in the left-right direction. In the present embodiment, two of the first vertical heaters 60 are arranged along the left-right direction. Each of the first vertical heaters 60 is arranged between the objects 2 adjacent in the left-right direction. The objects 2 are disposed on both right and left sides of each first vertical heater 60. Two rows of the objects 2 aligned in the left-right direction are arranged between two of the first vertical heaters 60. In a modification, a first row of the objects 2 only may be arranged between two of the first vertical heaters 60. In the left-right direction, each first vertical heater 60 is arranged between two of the conveying plates 16 adjacent in the left-right direction. The first vertical heaters 60 are arranged above the guide rail parts 56. The first vertical heaters 60 are inserted into the ceiling wall 30 in the up-down direction.

As shown in FIG. 4, a receiver 68 is defined on an upper surface 56a of each of the guide rail parts 56. The receiver 68 is recessed downward from the upper surface 56a. The receiver 68 extends on the upper surface 56a in the front-rear direction. A lower end of each first vertical heater 60 is received by the receiver 68. A width W1 of each first vertical heater 60 is smaller than an inner width W2 of the receiver 68 in the left-right direction. The inner width W2 is for example equal to or more than 1.1 times the width W1, is preferably equal to or more than 1.2 times the width W1, and is more preferably equal to or more than 1.3 times the width W1. Also, for example, the W1 is equal to or less than 2.0 times the inner width W2, is preferably equal to or less than 1.9 times the inner width W2, and is more preferably equal to or less than 1.8 times the inner width W2. According to these configurations, when each first vertical heater 60 thermally expands, the first vertical heater 60 can be suppressed from being pressed against the guide rail part 56 in the receiver 68, and when each first vertical heater 60 deforms by warping in the left-right direction, the first vertical heater 60 can be suppressed from slipping out of the receiver 68. For example, the inner width W2 is equal to or more than 1.1 times and equal to or less than 2.0 times the width W1, is preferably equal to or more than 1.2 times and equal to or less than 1.9 times the width W1, and is more preferably equal to or more than 1.3 times and equal to or less than 1.8 times the width W1.

The heat treatment furnace 10 further comprises protecting members 70, and an outer surface of each first vertical heater 60 is covered with the protecting member 70. The protecting members 70 are coated on the outer surfaces of the first vertical heaters 60. The protecting members 70 are constituted of alumina or mullite, for example. The protecting members 70 suppress substance(s) generated from the objects 2 during the heat treatment from making contact with the first vertical heaters 60. Due to this, the first vertical heaters 60 can be suppressed from being deteriorated, and thus service life of the first vertical heaters 60 can be prolonged. A width of each protecting member 70 is substantially the same as the width W1 of each first vertical heater 60 in the left-right direction. Here in FIG. 4, a thickness of the protecting member 70 is illustrated in a thickened exaggerated form. In a modification, each protecting member 70 may be a protector tube which covers the outer surface of each first vertical heater 60 with the protector tube being separated from the outer surface of each first vertical heater 60. In this configuration, the width of each protecting member 70 is substantially the same as the width W1 and the width of each first vertical heater 60 is smaller than the width W1.

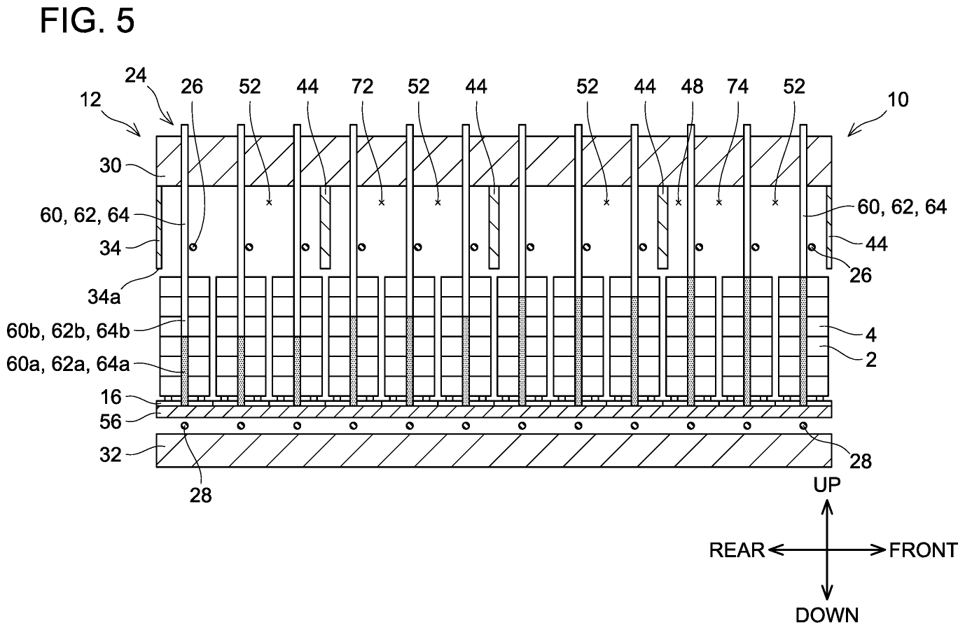

As shown in FIG. 5, each first vertical heater 60 comprises a first heating part 60a and a first non-heating part 60b. In FIG. 5, the first heating parts 60a are shaded with dots, whereas the first non-heating parts 60b are shown in white. When each first vertical heater 60 is powered, the first heating part 60a generates heat. A resistance per unit length of the first non-heating parts 60b is much smaller than a resistance per unit length of the first heating parts 60a, and is slightly greater than zero. Due to this, a heat generation amount per unit length of the first non-heating parts 60b is much smaller than a heat generation amount per unit length of the first heating parts 60a. Accordingly, each first vertical heater 60 is configured to generate heat by the first heating part 60a.

Each of the first heating parts 60a and the first non-heating parts 60b extends in the up-down direction. In each first vertical heater 60, the first heating part 60a extends upward from a lower end of the first vertical heater 60 to a certain position, and the first non-heating part 60b extends upward from the certain position to an upper end of the first vertical heater 60. The first non-heating part 60b is disposed above the first heating part 60a.

A length in the up-down direction of each first heating part 60a gradually increases from the first vertical heater 60 closest to the entrance 34a toward the first vertical heater 60 closest to the exit 36a. Due to this, positions of upper ends of first heating parts 60a (as well as center positions of the first heating parts 60a in the up-down direction) become higher from the first vertical heater 60 closest to the entrance 34a toward the first vertical heater 60 closest to the exit 36a. Also, a plurality of the first vertical heaters 60 located in the same space 52 has a substantially same length in the up-down direction of the first heating part 60a. A temperature of the heat treatment space 48 gradually rises frontward from the entrance 34a, and becomes constant thereon. Hereafter, in the heat treatment space 48, a space where the temperature of the heat treatment space 48 rises will be referred to as a temperature-rising space 72, and a space where the temperature of the heat treatment space 48 is constant will be referred to as a maintained space 74. In the present embodiment, in the front-rear direction, nine of the first vertical heaters 60 are disposed in the temperature-rising space 72 and the others of the first vertical heaters 60 are disposed in the maintained space 74.

As shown in FIG. 2, each of the second vertical heaters 62 extends in the up-down direction. The plurality of second vertical heaters 62 is spaced from each other in the front-rear direction. The number of the plurality of second vertical heaters 62 is equal to the number of the plurality of first vertical heaters 60 aligned in the front-rear direction. In the left-right direction, the second vertical heaters 62 are disposed between the right sidewall 38 and a right end of one of the conveying plates 16 adjacent to the right sidewall 38. The objects 2 are arranged only on the left sides of the second vertical heaters 62. Also, each second vertical heater 62 is aligned in one line with two of the first vertical heaters 60 in the left-right direction. Two rows of the objects 2 aligned in the left-right direction are arranged between the second vertical heaters 62 and the first vertical heaters 60. In a modification, one row of the objects 2 only may be arranged between the second vertical heaters 62 and the first vertical heaters 60. The second vertical heaters 62 are arranged above one of the guide rail parts 56. The second vertical heaters 62 are inserted into the ceiling wall 30 in the up-down direction.

As shown in FIG. 4, a lower end of each second vertical heater 62 is received by the receiver 68. A width W3 in the left-right direction of each second vertical heater 62 is substantially equal to the width W1 in the left-right direction of each first vertical heater 60. Further, an outer surface of each second vertical heater 62 is covered with the protecting member 70.

As shown in FIG. 5, each second heater 62 comprises a second heating part 62a and a second non-heating part 62b. When each second vertical heater 62 is powered, the second heating part 62a generates heat. A resistance per unit length of the second non-heating parts 62b is much smaller than a resistance per unit length of the second heating parts 62a, and is slightly greater than zero. Due to this, a heat generation amount per unit length of the second non-heating parts 62b is much smaller than a heat generation amount per unit length of the second heating parts 62a. Accordingly, each second vertical heater 62 is configured to generate heat by the second heating part 62a.

Among each first vertical heater 60 and each second vertical heater 62 aligned in the left-right direction, a length in the up-down direction of the second heating part 62a is substantially equal to a length in the up-down direction of the first heating part 60a, and respective positions of a lower end and an upper end of the second heating part 62a are substantially equal to those of a lower end and an upper end of the first heating part 60a. Also, a resistance per unit length of the first heating parts 60a is greater than a resistance per unit length of the second heating parts 62a. Due to this, a heat generation amount per unit length of the first heating parts 60a is greater than a heat generation amount per unit length of the second heating parts 62a. Since the length in the up-down direction of the first heating part 60a is substantially equal to the length in the up-down direction of the second heating part 62a, the heat generation amount of each first vertical heater 60 is greater than the heat generation amount of each second vertical heater 62. For example, the heat generation amount of each first vertical heater 60 is equal to or more than 1.3 times the generation amount of each second vertical heater 62, is preferably equal to or more than 1.5 times the generation amount of each second vertical heater 62, and is more preferably equal to or more than 1.7 times the generation amount of each second vertical heater 62. Also, the heat generation amount of each first vertical heater 60 is equal to or less than 2.7 times the heat generation amount of each second vertical heater 62, is preferably equal to or less than 2.5 times the heat generation amount of each second vertical heater 62, and is more preferably equal to or less than 2.1 times the heat generation amount of each second vertical heater 62. According to these configurations, uneven heating in the left-right direction can be suppressed from occurring among the plurality of objects 2 aligned in the left-right direction. The heat generation amount of each first vertical heater 60 is for example equal to or more than 1.3 times and equal to or less than 2.7 times that of each second vertical heater 62, is preferably equal to or more than 1.5 times and equal to or less than 2.5 times that of each second vertical heater 62, and is more preferably equal to or more than 1.7 times and equal to or less than 2.1 times that of each second vertical heater 62.

As shown in FIG. 2, each of the third vertical heaters 64 extends in the up-down direction. The plurality of third vertical heaters 64 is spaced from each other in the front-rear direction. The number of the plurality of third vertical heaters 64 is equal to the number of the plurality of second vertical heaters 62. In the left-right direction, the third vertical heaters 64 are disposed between the left sidewall 40 and a left end of one of the conveying plates 16 adjacent to the left sidewall 40. Also, each third vertical heater 64 is aligned in one line with two of the first vertical heaters 60 in the left-right direction. Two of the first vertical heaters 60, one of the second vertical heaters 62, and one of the third vertical heaters 64 are aligned in one line with each other in the left-right direction. Two rows of the objects 2 aligned in the left-right direction are disposed between the third vertical heaters 64 and the first vertical heaters 60. In a modification, only one row of the objects 2 may be disposed between the third vertical heaters 64 and the first vertical heaters 60. The third vertical heaters 64 are disposed above the guide rail parts 56. The third vertical heaters 64 are inserted into the ceiling wall 30 of the furnace body 12 in the up-down direction.

As shown in FIG. 4, a lower end of each third vertical heater 64 is received by the receiver 68. A width W4 in the left-right direction of each third vertical heater 64 is substantially equal to the width W1 in the left-right direction of each first vertical heater 60. Also, an outer surface of each third vertical heater 64 is covered with the protecting member 70.

As shown in FIG. 5, each third vertical heater 64 comprises a third heating part 64a and a third non-heating part 64b. When each third vertical heater 64 is powered, the third heating part 64a generates heat. A resistance per unit length of the third non-heating parts 64b is much smaller than a resistance per unit length of the third heating parts 64a, and is slightly greater than zero. Due to this, a heat generation amount per unit length of the third non-heating parts 64b is much smaller than a heat generation amount per unit length of the third heating parts 64a. Accordingly, each third vertical heater 64 is configured to generate heat by the third heating part 64a.

Among each first vertical heater 60 and each third vertical heater 64 aligned in the left-right direction, a length in the up-down direction of the third heating part 64a is substantially equal to a length in the up-down direction of the first heating part 60a, and respective positions of a lower end and an upper end of the third heating part 64a are substantially equal to those of the lower end and the upper end of the first heating part 60a. Also, a resistance per unit length of the third heating parts 64a is substantially equal to the resistance per unit length of the second heating parts 62a. Due to this, a heat generation amount per unit length of the third heating parts 64a is substantially equal to the heat generation amount per unit length of the second heating parts 62a. Since the length in the up-down direction of the third heating part 64a is substantially equal to the length in the up-down direction of the second heating part 62a, the heat generation amount of each third vertical heater 64 is substantially equal to the heat generation amount of each second vertical heater 62. Also, the heat generation amount per unit length of the first heating parts 60a is greater than the heat generation amount per unit length of the third heating parts 64a. Since the length in the up-down direction of the first heating part 60a is substantially equal to the length in the up-down direction of the third heating part 64a, the heat generation amount of each first vertical heater 60 is greater than the heat generation amount of each third vertical heater 64. For example, the heat generation amount of each first vertical heater 60 is equal to or more than 1.3 times the generation amount of each third vertical heater 64, is preferably equal to or more than 1.5 times the generation amount of each third vertical heater 64, and is more preferably equal to or more than 1.7 times the generation amount of each third vertical heater 64. Also, the heat generation amount of each first vertical heater 60 is equal to or less than 2.7 times the heat generation amount of each third vertical heater 64, is preferably equal to or less than 2.5 times the heat generation amount of each third vertical heater 64, and is more preferably equal to or less than 2.1 times the heat generation amount of each third vertical heater 64. According to these configurations, uneven heating in the left-right direction can be suppressed from occurring among the plurality of objects 2 aligned in the left-right direction. The heat generation amount of each first vertical heater 60 is for example equal to or more than 1.3 times and equal to or less than 2.7 times that of each third vertical heater 64, is preferably equal to or more than 1.5 times and equal to or less than 2.5 times that of each third vertical heater 64, and is more preferably equal to or more than 1.7 times and equal to or less than 2.1 times that of each third vertical heater 64.

As shown in FIG. 2, the plurality of upper heaters 26 is disposed in the heat treatment space 48. Each upper heater 26 extends in the left-right direction. The upper heaters 26 are inserted into the ceiling wall 30 in the left-right direction. As shown in FIG. 5, the plurality of upper heaters 26 is disposed at intervals from each other in the front-rear direction. The upper heaters 26 are disposed above uppermost objects 2 among the plurality of objects 2 stacked in the up-down direction. The upper heaters 26 are configured to heat-treat the objects 2 from above by generation of heat.

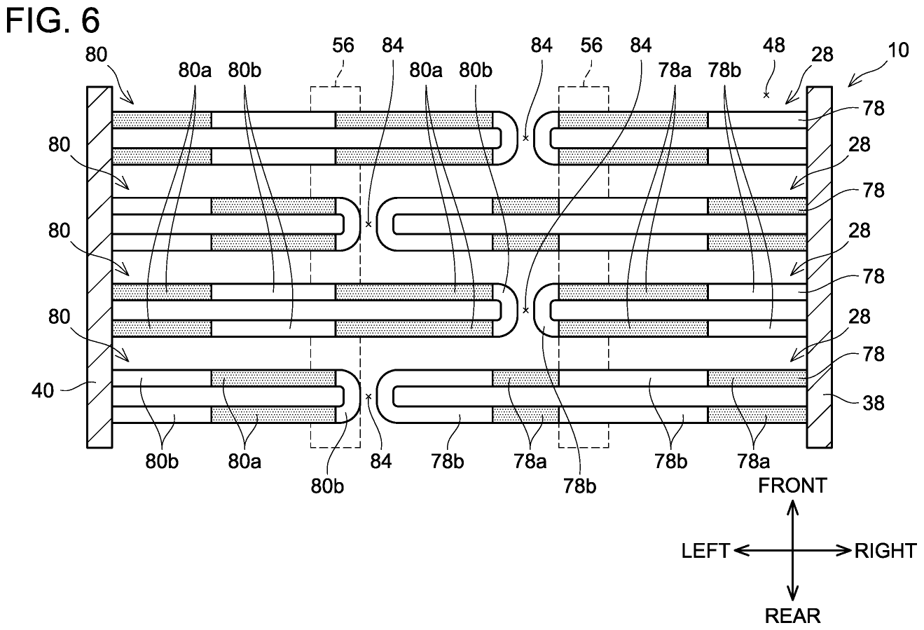

As shown in FIG. 2, the plurality of lower heaters 28 is disposed in the heat treatment space 48. The plurality of lower heaters 28 is disposed below both the conveying plates 16 and the guide rail parts 56. As shown in FIG. 6, the plurality of lower heaters 28 is disposed at intervals in the front-rear direction. Each lower heater 28 extends in the left-right direction. The plurality of lower heaters 28 comprises a plurality of first lower heaters 78 and a plurality of second lower heaters 80.

Each of the first lower heaters 78 has a substantially U shape. The plurality of first lower heaters 78 is aligned in the front-rear direction. The first lower heaters 78 are inserted into the right sidewall 38 in the left-right direction. Each first lower heater 78 extends leftward from the right sidewall 38 toward the left sidewall 40 in the heat treatment space 48. Each first lower heater 78 comprises one or more first lower heating parts 78a and one or more first non-heating parts 78b. In FIG. 6, the first lower heating parts 78a are shaded with dots, and the first lower non-heating parts 78b are shown in white. In the present embodiment, a total of the number of the first lower heating part(s) 78a and the number of the first lower non-heating part(s) 78b in one first lower heater 78 is five or seven.

When each first lower heater 78 is powered, the first lower heating part(s) 78a generate heat. A resistance per unit length of the first lower non-heating parts 78b is much smaller than a resistance per unit length of the first lower heating part 78a, and is slightly greater than zero. Due to this, a heat generation amount per unit length of the first lower non-heating parts 78b is much smaller than a heat generation amount per unit length of the first lower heating parts 78a. Accordingly, each first lower heater 78 is configured to generate heat by the first lower heating part(s) 78a.

In one first lower heater 78, the first lower heating part(s) 78a and the first lower non-heating part(s) 78b are alternately aligned in a longitudinal direction of the first lower heater 78. In the first lower heaters 78 adjacent to each other in the front-rear direction, the first lower heating part(s) 78a and the first lower non-heating part(s) 78b face each other in the front-rear direction. Between the two first lower heaters 78 adjacent in the front-rear direction, positions in the left-right direction of the first lower heating part(s) 78a differ from each other and also positions in the left-right direction of the first lower non-heating part(s) 78b differ from each other.

Each of the second lower heaters 80 has a substantially U shape. The plurality of second lower heaters 80 is aligned in the front-rear direction. The second lower heaters 80 are inserted into the left sidewall 40 in the left-right direction. Each second lower heater 80 extends rightward from the left sidewall 40 toward the right sidewall 38 in the heat treatment space 48. Each second lower heater 80 is aligned with a corresponding one of the first lower heaters 78 in the left-right direction. A right end (free end) of each second lower heater 80 faces and is separate from a left end (free end) of the corresponding first lower heater 78 in the left-right direction. Due to this, a facing region 84 is defined between the right end of each second lower heater 80 and the left end of the corresponding first lower heater 78. A width in the left-right direction of the facing region 84 is equal among all the facing regions 84. Positions of the two facing regions 84 that are adjacent to each other in the front-rear direction differ from each other in the left-right direction.

Each second lower heater 80 comprises one or more second lower heating parts 80a and one or more second lower non-heating parts 80b. In the present embodiment, a total of the number of the second lower heating part(s) 80a and the number of the second lower non-heating part(s) 80b in one second lower heater 80 is five or seven. The second lower heater 80 with the total of the number of second lower heating part(s) 80a and the number of the second lower non-heating part(s) 80b being five is aligned in the left-right direction with the first lower heater 78 with the total of the number of the first lower heating part(s) 78a and the number of the first lower non-heating part(s) 78b being seven. The second lower heater 80 with the total of the number of the second lower heating part(s) 80a and the number of the second lower non-heating part(s) 80b being seven is aligned in the left-right direction with the first lower heater 78 with the total of the number of the first lower heating part(s) 78a and the number of the first lower non-heating part(s) 78b being five.

When each second lower heater 80 is powered, the second lower heating part(s) 80a generate heat. A resistance per unit length of the second lower non-heating parts 80b is much smaller than a resistance per unit length of the second lower heating parts 80a, and is slightly greater than zero. Due to this, a heat generation amount per unit length of the second lower non-heating parts 80b is much smaller than a heat generation amount per unit length of the second lower heating parts 80a. Accordingly, each second lower heater 80 is configured to generate heat by the second lower heating part(s) 80a. Also, a resistance per unit length of the second lower heating parts 80a is substantially equal to the resistance per unit length of the first lower heating parts 78a. Due to this, a heat generation amount per unit length of the second lower heating parts 80a is substantially equal to the heat generation amount per unit length of the first lower heating parts 78a.

In one second lower heater 80, the second lower heating part(s) 80a and the second lower non-heating part(s) 80b are alternately aligned in a longitudinal direction of the second lower heater 80. In the second lower heaters 80 adjacent to each other in the front-rear direction, the second lower heating part(s) 80a and the second lower non-heating part(s) 80b face each other in the front-rear direction. Between the two second lower heaters 80 adjacent in the front-rear direction, positions in the left-right direction of the second lower heating part(s) 80a differ from each other and also positions in the left-right direction of the second lower non-heating part(s) 80b differ from each other.

Positions in the left-right direction of the plurality of facing regions 84 vary between the facing region 84 positioned closest to the entrance 34a and the facing region 84 closest to the exit 36a. The position in the left-right direction of an odd-numbered facing region 84 counted frontward from the entrance 34a is a first position, whereas the position in the left-right direction of an even-numbered facing region 84 counted frontward from the entrance 34a is a second position different from the first position. That is, the facing regions 84 the left-right directional position of which is the first region and the facing regions 84 the left-right directional position of which is the second position are alternately aligned frontward from the facing region 84 closest to the entrance 34a to the facing region 84 closest to the exit 36a.

In the two lower heaters 28 adjacent to each other in the front-rear direction (i.e., two pairs of the first lower heater 78 and the second lower heater 80), an entirety of each first lower heating part 78a of one of the first lower heaters 78 is arranged facing the first lower non-heating part 78b of the other first lower heater 78, the second lower non-heating part 80b of the second lower heater 80, and/or the facing region 84 in the front-rear direction. Likewise, an entirety of each second lower heating part 80a of one of the second lower heaters 80 is arranged facing the second lower non-heating part 80b of the other second lower heater 80, the first lower non-heating part 78b of the first lower heater 78, and/or the facing region 84 in the front-rear direction. For these reasons, in the two lower heaters 28 adjacent in the front-rear direction, the first lower heating parts 78a are not arranged facing the second lower heating parts 80a in the front-rear direction. Due to this, uneven heating in the left-right direction by the lower heaters 28 can be suppressed from occurring between the lower heater 28 closest to the entrance 34a and the lower heater 28 closest to the exit 36a.

In the two lower heaters 28 adjacent in the front-rear direction, an entirety of each first lower non-heating part 78b of one of the first lower heaters 78 is arranged facing the first lower heating part 78a of the other first lower heater 78 or the second lower heating part 80a of the second lower heater 80 in the front-rear direction. Likewise, an entirety of each second lower non-heating part 80b of one of the second lower heaters 80 is arranged facing the second lower heating part 80a of the other second lower heater 80 or the first lower heating part 78a of the first lower heater 78 in the front-rear direction. Furthermore, an entirety of each facing region 84 is arranged facing the first lower heating part(s) 78a or the second lower heating part(s) 80a in the front-rear direction. For these reasons, in the two lower heaters 28 adjacent in the front-rear direction, each first lower non-heating part 78b is not arranged facing the respective second lower non-heating parts 80b or the respective facing regions 84 in the front-rear direction, and each second lower non-heating part 80b is not arranged facing the facing regions 84 in the front-rear direction. Due to this, uneven heating in the left-right direction by the lower heaters 28 can be suppressed from occurring between the lower heater 28 closest to the entrance 34a and the lower heater 28 closest to the exit 36a.

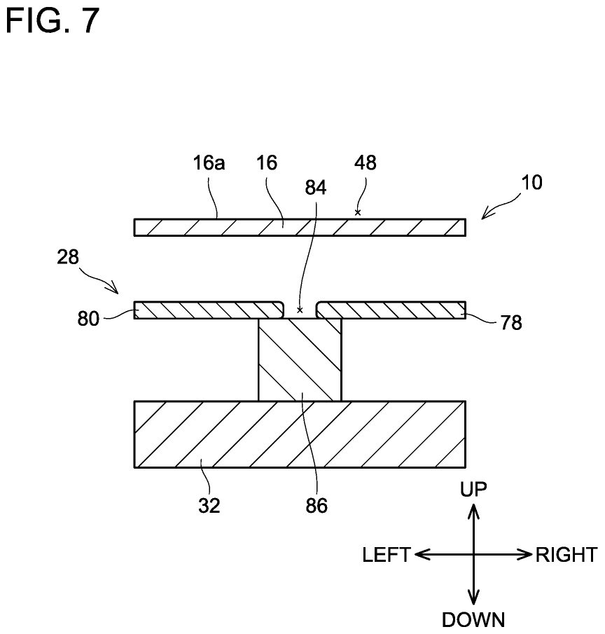

As shown in FIG. 7, the heat treatment furnace 10 further comprises supports 86. The supports 86 are arranged in the heat treatment space 48. The supports 86 are supported by the bottom wall 32. The supports 86 are disposed below the first lower heaters 78, the second lower heaters 80, and the facing regions 84. Each support 86 is in contact with the left end of one of the first lower heaters 78 and the right end of one of the second lower heaters 80 from below. Each support 86 supports the left end of one of the first lower heaters 78 and the right end of one of the second lower heaters 80 from below. Due to this, the first lower heaters 78 and the second lower heaters 80 can be suppressed from being deformed in a manner that the positions of the left ends of the first lower heaters 78 and the positions of the right ends of the second lower heaters 80 lower down.

In the above embodiment, the positions in the up-down direction of the first heating parts 60a of the first vertical heaters 60 vary from the first vertical heater 60 closest to the entrance 34a toward the first vertical heater 60 closest to the exit 36a. According to the above configuration, the positions in the up-down direction of the first heating parts 60a of the plurality of first vertical heaters 60 vary within the furnace body 12. Due to this, an occurrence of a situation where a certain object 2 among the plurality of objects 2 stacked in the up-down direction is heated excessively compared to other objects 2 can be suppressed. For this reason, uneven heating in the up-down direction can be suppressed from occurring among the plurality of objects 2 stacked in the up-down direction.

### (Correspondence Relationships)

The first vertical heaters 60 are an example of “first heaters.” The second vertical heaters 62 are an example of “second heaters.” The third vertical heaters 64 are an example of “third heaters.” The first lower heaters 78 are an example of “fourth heaters.” The second lower heaters 80 are an example of “fifth heaters.” The left end of each of the first lower heaters 78 is an example of “end of each of the plurality of fourth heaters.” The right end of each of the second lower heaters 80 is an example of “end of a corresponding one of the plurality of fifth heaters”.

### Second Embodiment

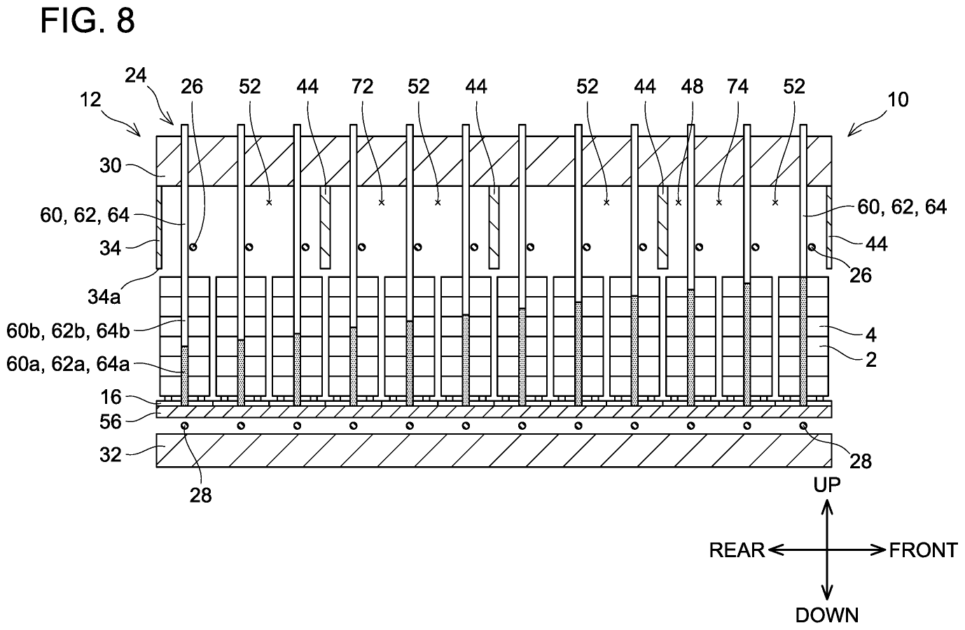

In a second embodiment, points different from the first embodiment will only be described. As shown in FIG. 8, in a plurality of first vertical heaters 60 disposed in a same space 52, a length in the up-down direction of a first heating part 60a gradually increases as it is farther frontward away from an entrance 34a. In a plurality of second vertical heaters 62 disposed in the same space 52, a length in the up-down direction of a second heating part 62a gradually increases as it is farther frontward away from the entrance 34a. In a plurality of third vertical heaters 64 disposed in the same space 52, a length in the up-down direction of a third heating part 64a gradually increases as it is farther frontward away from the entrance 34a.

### Third Embodiment

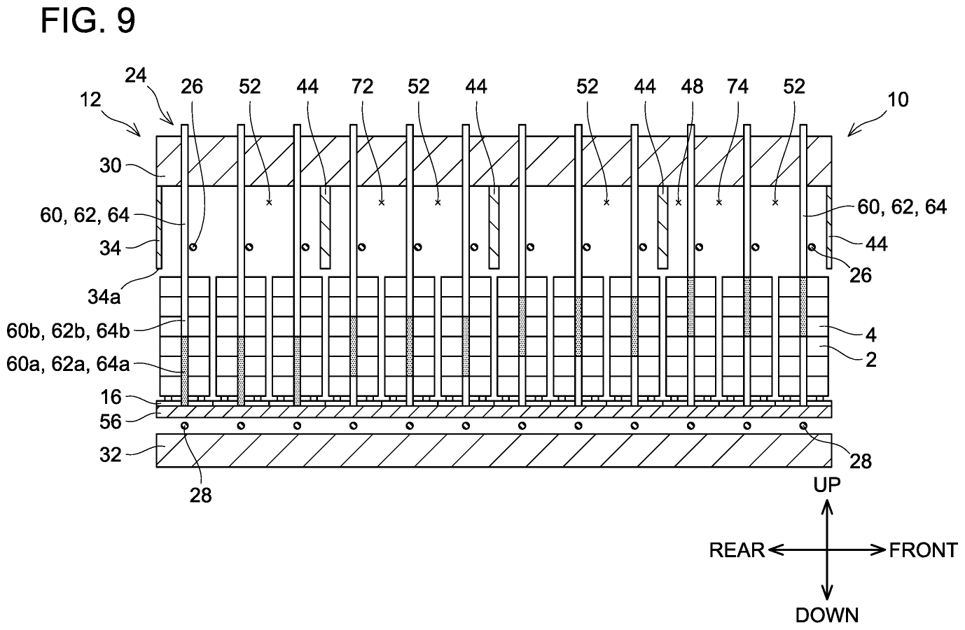

In a third embodiment, points different from the first embodiment will only be described. As shown in FIG. 9, lengths in the up-down direction of all first heating parts 60a are substantially equal. In a plurality of a plurality of first vertical heaters 60 arranged in a same space 52 partitioned by a plurality of partitioning walls 44 aligned frontward, positions in the up-down direction of the first heating parts 60a in the respective first vertical heaters 60 are substantially equal. In a plurality of the spaces 52, the position in the up-down direction of the first heating part 60a in each first vertical heater 60 becomes higher as it goes from the space 52 closest to an entrance 34a to the space 52 closest to an exit 36a.

A configuration in the up-down direction of second heating parts 62a in the second vertical heaters 62 is substantially equal to the configuration of the first heating parts 60a in the first vertical heaters 60. Also, a configuration in the up-down direction of third heating parts 64a in the third vertical heaters 64 is substantially equal to the configuration in the up-down direction of the first heating parts 60a in the first vertical heaters 60. Due to this, detailed description for the second heating parts 62a and the third heating parts 64a will be omitted.

### Fourth Embodiment

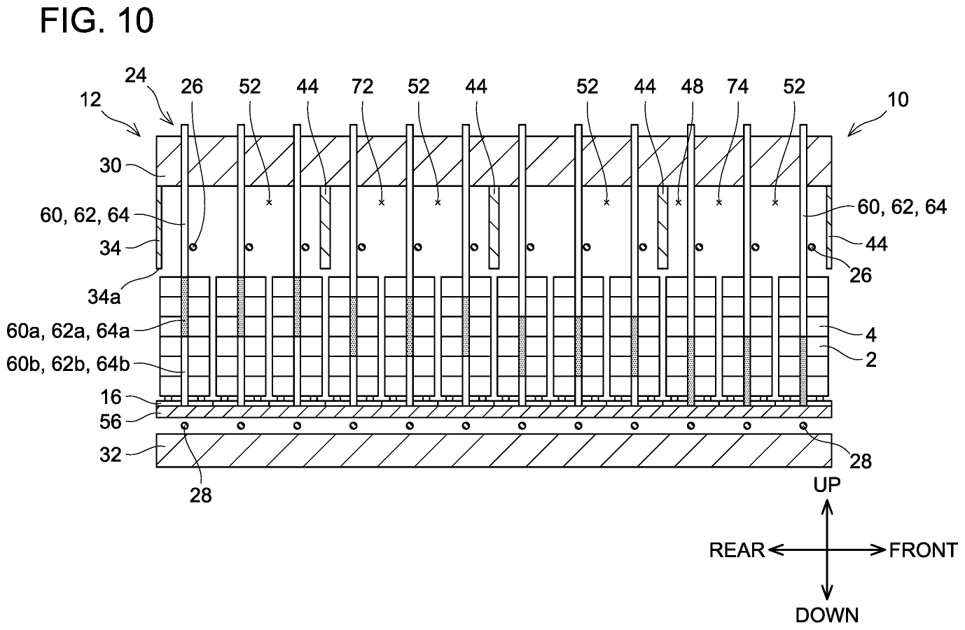

In a fourth embodiment, points different from the first embodiment will only be described. As shown in FIG. 10, in a plurality of spaces 52, a position of a first heating part 60a in each first vertical heater 60 gradually becomes lower as it goes from the space 52 closest to an entrance 34a toward the space 52 closest to an exit 36a. Further, in the plurality of spaces 52, positions in the up-down direction of second heating parts 62a in the second vertical heaters 62 gradually become lower as they go from the space 52 closest to the entrance 34a toward the space 52 closest to the exit 36a. Furthermore, in the plurality of spaces 52, a position in the up-down direction of a third heating part 64a in each third vertical heater 64 gradually becomes lower as it goes from the space 52 closest to the entrance 34a toward the space 52 closest to the exit 36a.

### Fifth Embodiment

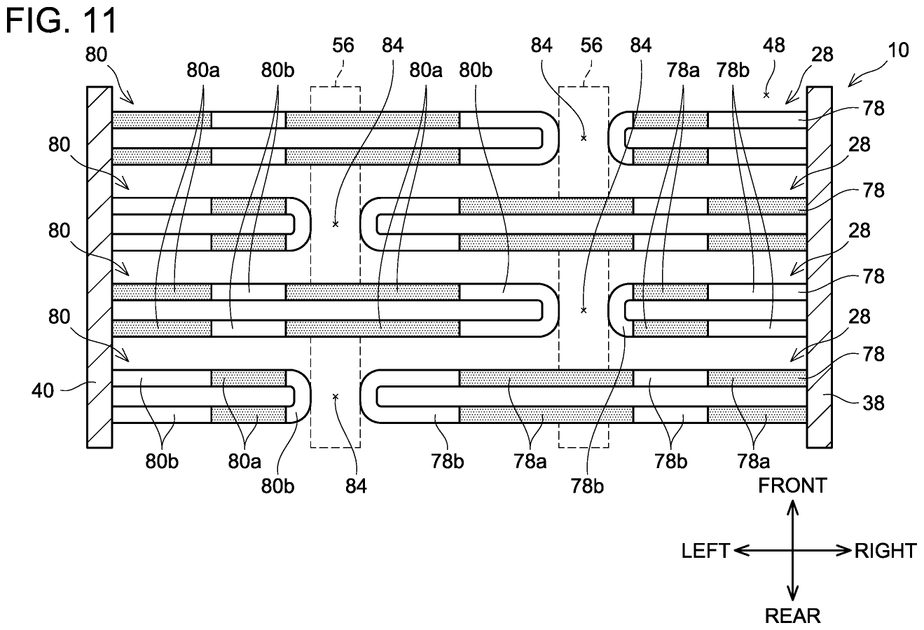

In a fifth embodiment, points different from the first embodiment will only be described. As shown in FIG. 11, each of facing regions 84 is disposed directly below one of guide rail parts 56. Due to this, each facing region 84 overlaps the corresponding guide rail part 56 in the up-down direction. An odd-numbered facing region 84 counted frontward from an entrance 34a overlaps a certain guide rail part 56 in the up-down direction whereas an even-numbered facing region 84 counted frontward from the entrance 34a overlaps another guide rail part 56 in the up-down direction. In two of the facing regions 84 adjacent in the front-rear direction, the guide rail part 56 overlapping one of the two facing regions 84 in the up-down direction is different from the guide rail part 56 overlapping the other of the two facing regions 84 in the up-down direction.

### Sixth Embodiment

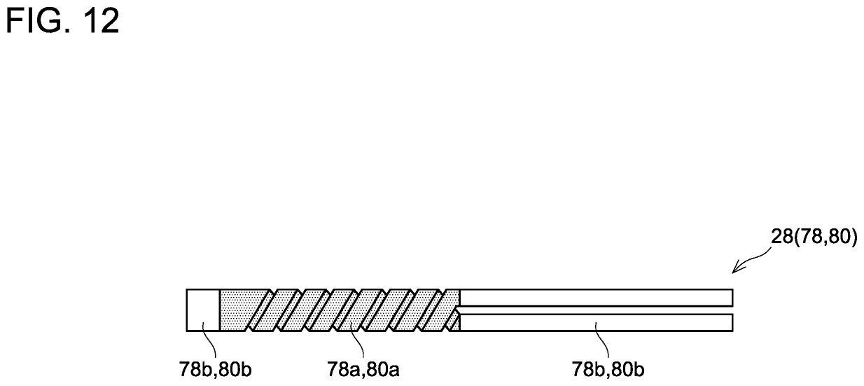

In a sixth embodiment, points different from the first embodiment will only be described. As shown in FIG. 12, each first lower heater 78 and each second lower heater 80 have a spiral shape. A first lower heating part 78a of each first lower heater 78 extends spirally. The first lower heating part 78a extends in the left-right direction. When each first lower heater 78 is powered, the first lower heating part 78a generates heat. A first lower non-heating part 78b of each first lower heater 78 extends linearly in the left-right direction. Because a configuration of each second lower heater 80 is substantially equal to that of each first lower heater 78, detailed description of each second lower heater 80 will be omitted.

### Modification

In one embodiment, one or more of the lower heaters 28 may be a single heater extending from the right sidewall 38 to the left sidewall 40. In this configuration, the lower heater(s) 28 are inserted into both the right sidewall 38 and the left sidewall 40.

In the fifth embodiment, each of the first lower heaters 78 may comprise only the first lower heating part 78a, and each of the second lower heaters 80 may comprise only the second lower heating part 80a.

Specific examples of the disclosure herein have been described in detail, however, these are mere exemplary indications and thus do not limit the scope of the claims. The art described in the claims includes modifications and variations of the specific examples presented above. Technical features described in the description and the drawings may technically be useful alone or in various combinations, and are not limited to the combinations as originally claimed. Further, the purpose of the examples illustrated by the present description or drawings is to satisfy multiple objectives simultaneously, and satisfying any one of those objectives gives technical utility to the present disclosure.

What is claimed is:

1. A heat treatment furnace comprising:
a furnace body comprising an entrance, an exit, and a heat treatment space having a temperature-rising space and a temperature-maintained space that are configured to thermally treat a plurality of objects;
conveying plates on which the plurality of objects is to be placed in a state of being stacked on one another in an up-down direction;
a pusher configured to push the conveying plates in a front direction from the entrance to the exit of the furnace body; and
a plurality of heaters extending in the up-down direction and aligned in the front direction in the heat treatment space,
wherein
each of the plurality of heaters comprises a heating part configured to generate heat, and
positions of the heating parts of the plurality of heaters in the up-down direction vary from the heater closest to the entrance toward the heater closest to the exit.

2. The heat treatment furnace according to claim 1, wherein
the front direction is perpendicular to the up-down direction,
the conveying plates are conveyed from the entrance to the exit by being pushed by the pusher with the conveying plates aligned in a left-right direction perpendicular to the up-down direction and the front direction,
the plurality of the heaters comprises:
a plurality of first heaters disposed between adjacent ones of the conveying plates in the left-right direction;
a plurality of second heaters aligned in the front direction and disposed between a right end of the conveying plates aligned in the left-right direction and the furnace body; and
a plurality of third heaters aligned in the front direction and disposed between a left end of the conveying plates aligned in the left-right direction and the furnace body, and
within the temperature-rising space, an amount of heat generation of each of the first heaters is greater than any of an amount of heat generation of each of the second heaters and an amount of heat generation of each of the third heaters.

3. The heat treatment furnace according to claim 2, wherein
the amount of heat generation of each of the first heaters is equal to or more than 1.3 times and equal to or less than 2.7 times the amount of heat generation of each of the second heaters, and
the amount of heat generation of each of the second heaters is substantially equal to the amount of heat generation of each of the third heaters.

4. The heat treatment furnace according to claim 1, wherein
the front direction is perpendicular to the up-down direction, and
the furnace body comprises:
a ceiling wall into which the plurality of heaters is inserted; and
a receiver configured to receive lower ends of the plurality of heaters.

5. The heat treatment furnace according to claim 4, further comprising a guide rail part configured to guide the conveying plates in the front direction, wherein
the receiver is arranged on an upper surface of the guide rail part.

6. The heat treatment furnace according to claim 4, wherein an inner width of the receiver is equal to or more than 1.1 times and equal to or less than 2.0 times a width of each of the plurality of heaters in a left-right direction perpendicular to the up-down direction and the front direction.

7. The heat treatment furnace according to claim 1, further comprising a protecting member configured to cover the plurality of heaters.

8. The heat treatment furnace according to claim 1, further comprising a spacer disposed between the conveying plates and the objects.

9. The heat treatment furnace according to claim 1, wherein
the front direction is perpendicular to the up-down direction,
the furnace body comprises a left sidewall and a right sidewall facing each other in a left-right direction perpendicular to the up-down direction and the front direction,
the heat treatment furnace comprises:
a plurality of fourth heaters disposed below the conveying plates, aligned in the front direction, and penetrating the right sidewall to extend from the right sidewall toward the left sidewall in the furnace body, and
a plurality of fifth heaters disposed below the conveying plates, aligned in the front direction, and penetrating the left sidewall to extend from the left sidewall toward the right sidewall in the furnace body,
an end of each of the plurality of fourth heaters and an end of corresponding one of the plurality of fifth heaters are separated and face each other in the left-right direction,
a facing region is defined between the end of each of the plurality of fourth heaters and the end of the corresponding one of the plurality of fifth heaters in the left-right direction, and
positions in the left-right direction of the facing regions vary between the facing region positioned closest to the entrance and the facing region closest to the exit.

10. The heat treatment furnace according to claim 9, wherein
each of the plurality of fourth heaters comprises a heating part and a non-heating part extending in the left-right direction,
each of the plurality of fifth heaters comprises a heating part and a non-heating part extending in the left-right direction,
positions of the non-heating parts of adjacent ones of the plurality of fourth heaters in the front direction differ from each other in the left-right direction,
positions of the non-heating parts of adjacent ones of the plurality of fifth heaters in the front direction differ from each other in the left-right direction, and
in one of the plurality of fourth heaters and one of the plurality of fifth heaters that are adjacent in the front direction,
the non-heating part of the fourth heater faces the heating part of another fourth heater or faces the heating part of the adjacent fifth heater in the front direction, and
the non-heating part of the fifth heater faces the heating part of the adjacent fourth heater or faces the heating part of another fifth heater in the front direction.

11. The heat treatment furnace according to claim 9, wherein
the front direction is perpendicular to the up-down direction,
the heat treatment furnace further comprises a plurality of guide rail parts, each of the plurality of guide rail parts being disposed between the conveying plates aligned in the left-right direction and configured to guide the conveying plates in the front direction,
each of the plurality of guide rail parts extends in the front direction,
the plurality of guide rail parts is disposed above the plurality of fourth heaters and the plurality of fifth heaters and separate from each other in the left-right direction, and
each of the facing regions is disposed at a position where the facing region overlaps one of the plurality of guide rail parts in the up-down direction.

12. The heat treatment furnace according to claim 11, wherein positions in the left-right direction of two of the facing regions adjacent in the front direction differ from each other.

13. The heat treatment furnace according to claim 9, further comprising a support configured to support the ends of the plurality of fourth heaters and the ends of the plurality of fifth heaters.
